(19) United States
(12) Patent Application Publication
(10) Pub. No.: US 2008/0267180 A1
(43) Pub. Date: Oct. 30, 2008

(54) Stacked tagging for broadcasting through hierarchy of meshes

(76) Inventor: Steven Glen Jorgensen, Newcastle, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,403

(22) Filed: Apr. 30, 2007

(51) Int. Cl. H04L 12/56

(52) U.S. Cl. 370/389; 370/401

(57) ABSTRACT

One embodiment relates to a method of processing a broadcast packet by a switch. If the packet is received from another switch within a same mesh, then the packet is flooded to appropriate destination ports based on a flood map corresponding to an existing mesh tag in the packet. If the packet is received from an end node, then a new mesh tag is added to the packet and then the packet is flooded to appropriate destination ports based on a flood map corresponding to the new mesh tag in the packet. If the packet is received from a meta mesh, then an existing meta-mesh tag is stripped from the packet, a mesh tag in the packet is modified, and the packet is flooded to appropriate destination ports based on a flood map corresponding to the modified mesh tag in the packet. Other embodiments, aspects and features are also disclosed.

### BACKGROUND OF THE INVENTION

1. Field of the Invention

The present invention relates generally to communication networks. More specifically, the present invention relates to network switches and switch-to-switch protocols.

2. Description of the Background Art

It is common in conventional computing environments to connect a plurality of computing systems and devices through a communication medium often referred to as a network. Such networks among communicating devices permit devices (or users of devices) to easily exchange and share information among the various devices. The Internet is a presently popular example of such networking on a global scale. Individual users attach their computers to the Internet, thereby enabling sharing of vast quantities of data on other computers geographically dispersed throughout the world.

Networked computing systems may be configured and graphically depicted in a wide variety of common topologies. In other words, the particular configurations of network communication links (also referred to as paths) and devices between a particular pair of devices wishing to exchange information may be widely varied. Any particular connection between two computers attached to a network may be direct or may pass through a large number of intermediate devices in the network. In addition, there may be a plurality of alternative paths through the network connecting any two network devices. Computing networks are therefore complex and vary in their configurations and topologies.

Certain network communication media and protocols are referred to as packet oriented. A protocol or communication medium may be said to be packet oriented in that information to be exchanged over the network is broken into discrete sized packets of information. A block of information to be transferred over the network is decomposed into one or more packets for purposes of transmission over the network. At the receiving end of the network transmission, the packets are re-assembled into the original block of data.

In general, each packet includes embedded control and addressing information that identifies the source device which originated the transmission of the packet and which identifies the destination device to which the packet is transmitted. Identification of source and destination devices is by means of an address associated with each device. An address is an identifier which is unique within the particular computing network to identify each device associated with the network. Such addresses may be unique to only a particular network environment (i.e., a network used to interconnect a single, self-contained computing environment) or may be generated and assigned to devices so as to be globally unique in co-operation with networking standards organizations.

In the networking layer 2 level of network communication, such addresses are often referred to as MAC address (Media ACcess address). Network protocols operable above this level of communication may use other addresses for other purposes in the higher-level communication techniques.

In many conventional commercially-available network environments, the network communication medium is in essence a bus commonly attached to a plurality of devices over which the devices exchange. In a simple networking topology, all devices may be attached to such a bus-structured common network medium. Any particular single network medium has a maximum data exchange bandwidth associated therewith. The maximum data exchange bandwidth of a medium is determined by a number of electrical and physical properties of the medium and protocols used to communicate over that medium. For example, a popular family of related network media and protocols are collectively referred to as Ethernet. Ethernet defines a standard protocol for the exchange of messages over the communication medium. A variety of communication media are also defined as part of the Ethernet family. The communication bandwidth of the Ethernet family of standards may change over time, but conventionally ranges from approximately 10 Mbit (megabits or million bits of information) per second to 1 Gbit (gigabits or billion bits of information) per second. Therefore, a single (slow) Ethernet connection, for example, has a maximum data exchange bandwidth of approximately 10 Mbit per second.

In conventional network computing environments, a number of devices are used in addition to interconnected computing systems to efficiently transfer data over the network. Routers and switches are in general network devices which segregate information flows over various segments of a computer network. A segment may be any subset of the network computing environment, including devices and their respective interconnecting communication links. A single computer network communication link may have a maximum data transfer bandwidth parameter defining the maximum rate of information exchange over that network. Where all devices on a computer network share a common network medium, the maximum bandwidth of the computer network may be rapidly reached. The overall performance of the networked computing environment may be thereby reduced because information exchange requests may have to await completion of earlier information exchange requests presently utilizing the communication link.

In particular, a switch device is a device that filters out packets on the network destined for devices outside a defined subset (segment) and forwards information directed between computing devices on different segments of a networked computing environment. The filtering and forwarding of such information is based on configuration information within the switch that describes the data packets to be filtered and forwarded in terms of source and/or destination address information (once address locations are “learned” by the switch(es)).

Network switch devices and protocols associated therewith are also used to manage redundant paths between network devices. Where there is but a single path connecting two network devices, that single path, including all intermediate devices between the source and destination devices, represent a single point of failure in network communications between that source and destination device. It is therefore common in network computing environments to utilize a plurality of redundant paths to enhance reliability of the network. One type of network with redundant paths is a network mesh or switching mesh.

It is desirable to improve networking and communications apparatus and methods.

### BRIEF DESCRIPTION OF THE DRAWINGS

FIG. 1 is a schematic diagram of a conventional switching mesh having redundant paths.

FIGS. 2A and 2B are flow charts depicting a conventional method of broadcasting packets through the switching mesh of FIG. 1.

FIG. 3 is a diagram of a conventional MAC broadcast packet.

FIG. 4 is a schematic diagram of a meta-mesh which encompasses multiple switching meshes in accordance with an embodiment of the invention.

FIG. 5 is a schematic diagram of a meta-meta-mesh which encompasses multiple meta-meshes in accordance with an embodiment of the invention.

FIG. 6 is a flow chart depicting a packet to be broadcast through a mesh hierarchy in accordance with an embodiment of the invention.

FIG. 7 is a flow chart depicting a method of broadcasting a packet through a meta-meta mesh of switches in accordance with an embodiment of the invention.

FIG. 8 is a flow chart depicting procedural steps performed by a meshing switch in processing a broadcast packet in accordance with an embodiment of the invention.

FIG. 9 is a diagram of an example switch in accordance with an embodiment of the invention.

### DETAILED DESCRIPTION

### Broadcasting Through a Switching Mesh

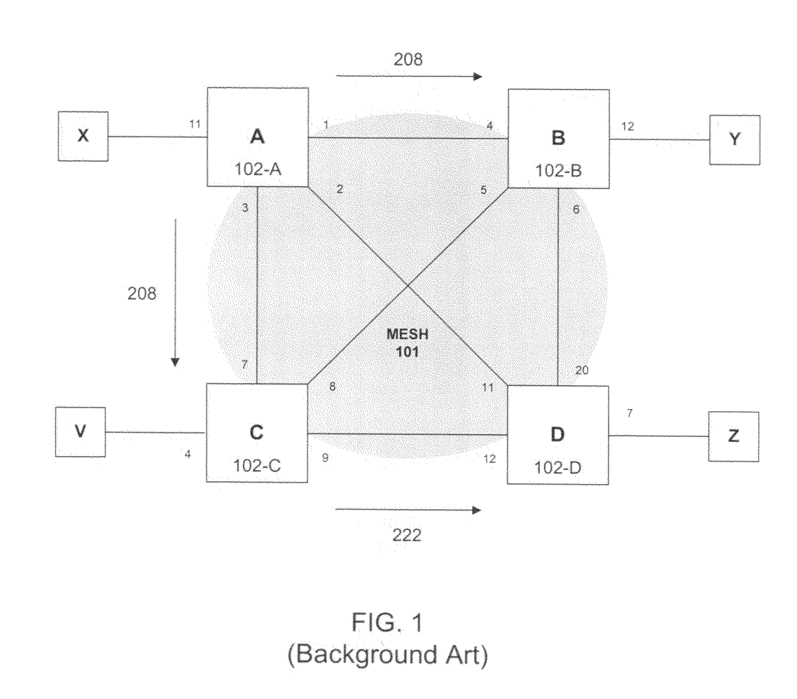

FIG. 1 is a schematic diagram of a conventional switching mesh 101 having various redundant paths. The switching (or network) mesh 101 includes four switching units 102 interconnected by way of a network of interconnections. For example, a communication line connects port 1 of switch A 102-A to port 4 of switch B 102-B. Another communication line connects port 8 of switch C 102-C to port 5 of switch B 102-B. And so on. These ports that interconnect two mesh switches 102 are referred to as “mesh” ports.

Other ports on the switches 102 are “non-mesh” ports in that they connect the switch 102 to a network device outside of the mesh 101. For example, port 11 of switch A 102-A is a non-mesh switch that connects to network device X. As another example, port 7 of switch D 102-D connects to network device Z. Of course, while the illustration of FIG. 1 shows only one non-mesh port per switch 102, each switch 102 may have multiple non-mesh ports connecting to various network devices (other switches, routers, hosts, and so on).

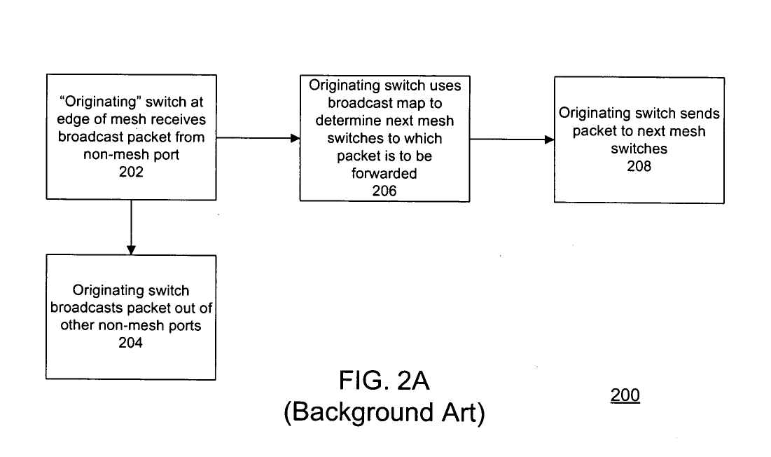

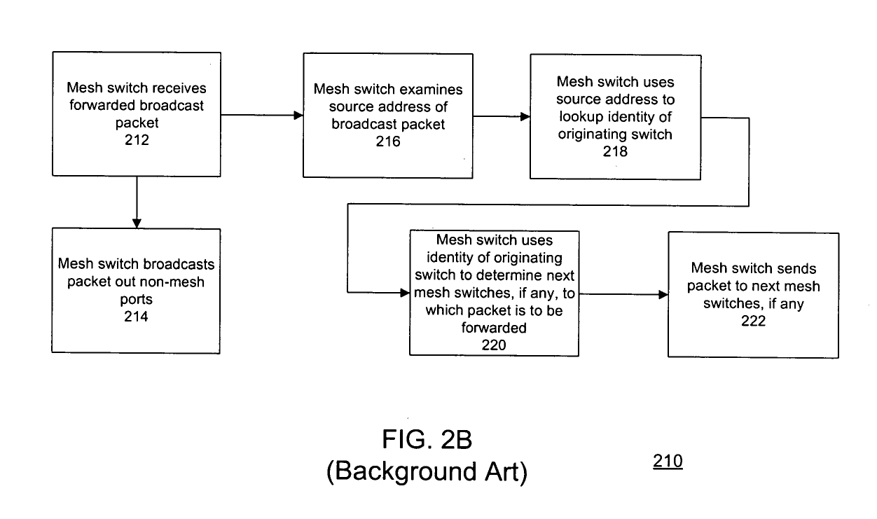

FIGS. 2A and 2B are flow charts depicting a conventional method of broadcasting packets through the switching mesh 101 of FIG. 1. FIG. 2A shows the procedure 200 performed by an “originating” mesh switch 102, and FIG. 2B shows the procedure 210 performed at other (non-originating) mesh switches 102.

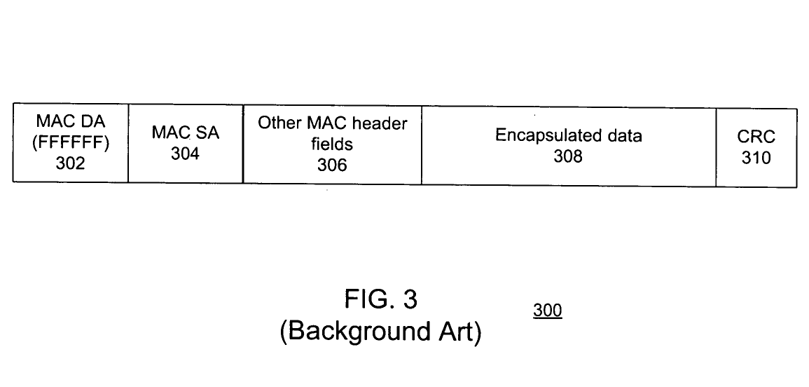

An example of a broadcast packet 300 is shown in FIG. 3. Per FIG. 3, the fields of the packet 300 include a MAC destination address (MAC DA) 302, a MAC source address (MAC SA) 304, other MAC header fields 306, encapsulated data 308, and a cyclic redundancy check (CRC) value 310. That the packet 300 is a broadcast packet is indicated by the MAC DA 302 being all ones (i.e. the six destination address bytes are FFFFFF).

Regarding the procedure 200 of the originating mesh switch 102 per FIG. 2A, consider a broadcast packet 300 that is received 202 from outside of the mesh 101 to a non-mesh port of the originating mesh switch 102. That the packet is a broadcast packet 300 is determined by examining the destination address 302. The originating switch 102 may be configured to broadcast 204 that packet out of its other non-mesh ports. Moreover, within the mesh 101, the originating mesh switch 102 determines 206 the next mesh switches 102 to which the packet is to be forwarded. The determination 206 of the next mesh switches 102 may be performed by a look-up to a broadcast map stored at the originating switch 102. The originating switch 102 then transmits or sends 208 the packet via mesh ports to each of these next mesh switches 102.

Regarding the procedure 210 of a non-originating mesh switch 102 per FIG. 2B, a non-originating mesh switch 102 receives 212 a forwarded broadcast packet 300 via a mesh port from another mesh switch 102. Again, that the packet is a broadcast packet 300 is determined by examining the destination address 302. The non-originating switch 102 may be configured to broadcast 214 that packet 300 out of its non-mesh ports. Moreover, the non-originating mesh switch 102 examines 216 the broadcast packet 300 to determine its source address 304, and uses the source address 304 to look-up 218 the identity of the originating switch 102. The non-originating switch 102 then uses the identity of the originating switch 102 to determine 220 the next mesh switches 102, if any, to which the packet 300 is to be forwarded. The determination 220 of the next mesh switches 102 may be performed by a look-up to broadcast map data for broadcasts packets 300 originally coming from that particular originating switch 102. The non-originating switch 102 then transmits or sends 222 the packet 300 via mesh ports to each of these next mesh switches 102, if any.

As a concrete example, consider that the originating mesh switch is switch A 102-A of FIG. 1. As such, switch A 102-A receives 202 a broadcast packet 300 on one of its non-mesh ports to be broadcast through the mesh 101. In this specific example, the broadcast map at switch A 102-A indicates that the next mesh switches are switches B 102-B and C 102-C. Hence, the packet 300 is forwarded 208 to both switches B 102-B (via port 1) and C 102-C (via port 3), as indicated by the arrows labeled 208 in FIG. 1.

Switch B 102-B receives 212 the forwarded packet 300 on its port 4, and switch C 102-C receives 212 the forwarded packet 300 on its port 7. In this specific example, the broadcast map data at switch B 102-B for packets 300 originating from switch A 102-A indicates that there is no next switch. However, the broadcast map data at switch C 102-C for packets 300 originating from switch A 102-A indicates that there is a next mesh switch, and the next mesh switch is indicated to be switch D 102-D. As such, the packet is forwarded 222 from switch C 102-C (via port 9) to switch D 102-D, as indicated by the arrow labeled 222 in FIG. 1. Switch D 102-D receives 212 the forwarded packet 300 on its port 12. The broadcast map data at switch D 102-D for packets 300 originating from switch A 102-A indicates that there is no next switch, so there is no need to further forward the packet 300 within the mesh 101.

### Broadcasting Through Mesh Hierarchy

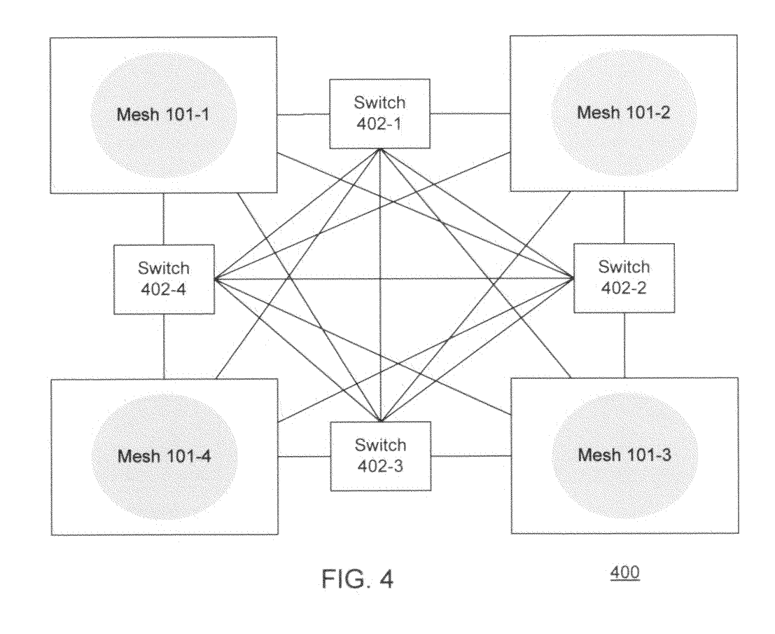

FIG. 4 is a schematic diagram of a meta-mesh 400 which encompasses multiple switching meshes 101 in accordance with an embodiment of the invention. In the example shown in FIG. 4, the meta-mesh 400 encompasses four meshes 101-1,101-2,101-3, and 101-4. In general, the meta-mesh 400 may encompass a variable number of meshes 101 within the limits of the particular protocol that is implemented. For example, other meta-meshes 400 may encompass two meshes, three meshes, five meshes, six meshes and so on.

Multiple meta-meshing switches 402 are shown which implement the meta-meshing protocol. Although there are four such switches (402-1, 402-2, 402-3, and 402-4) in the example shown, there need not be a one-to-one correspondence between the number of meta-meshing switches 402 and the number of meshes 101 in the meta-mesh 400. In the example illustrated, each meta-meshing switch 402 is interconnected with each of the other meta-meshing switches 402 and also is interconnected with each of the meshes 101. In other implementations, each meta-meshing switch 402 need not be interconnected with each of other meta-meshing switches 402 and also need not be interconnected with each of the meshes 101.

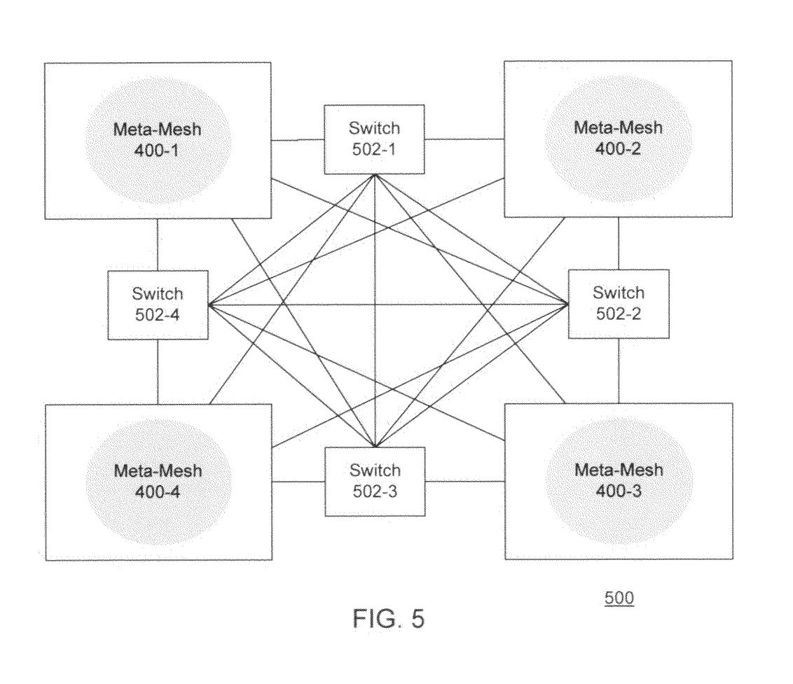

FIG. 5 is a schematic diagram of a meta-meta-mesh (“meta²-mesh”) 500 which encompasses multiple meta-meshes 400 in accordance with an embodiment of the invention. In the example shown in FIG. 5, the meta²-mesh 500 encompasses four meta-meshes 400-1, 400-2, 400-3, and 400-4. In general, the meta -mesh 500 may encompass a variable number of meta-meshes 400 within the limits of the particular protocol that is implemented. For example, other meta -mesh 500 may encompass two meta-meshes, three meta-meshes, five meta-meshes, six meta-meshes and so on.

Multiple meta²-meshing switches 502 are shown which implement the meta 2-meshing protocol. Although there are four such switches (502-1, 502-2, 502-3, and 502-4) in the example shown, there need not be a one-to-one correspondence between the number of meta²-meshing switches 502 and the number of meta-meshes 400 in the meta²-mesh 500. In the example illustrated, each meta²-meshing switch 502 is interconnected with each of the other meta²-mesh switches 502 and also is interconnected with each of the meta-meshes 400. In other implementations, each meta²-meshing switch 502 need not be interconnected with each of other meta²-meshing switches 502 and also need not be interconnected with each of the meta-meshes 400.

Together, FIGS. 1, 4 and 5 depict a three-level meshing hierarchy where the first level corresponds to meshing of switches to form meshes, the second level corresponds to meshing of meshes to form a meta-mesh, and the third level corresponds to meshing of meta-meshes to form a meta²-mesh. While three hierarchical levels of meshing are shown in FIGS. 1, 4, 5, the meshing hierarchy may be extended to further levels of meshing in accordance with embodiments of the invention. For example, meshing of meta²-meshes may be done to form a meta³-mesh. Meshing of meta³-meshes may be done to form a meta⁴-mesh. And soon.

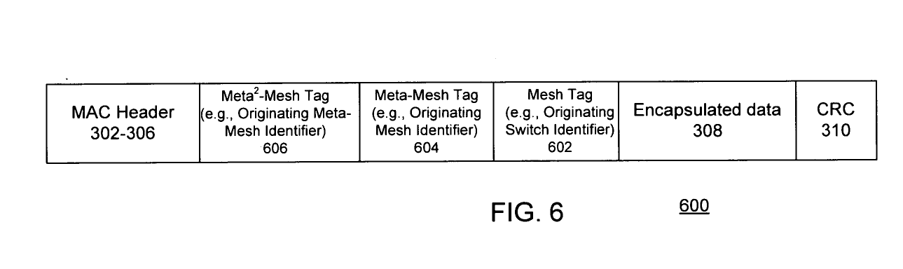

FIG. 6 is a flow chart depicting a packet 600 to be broadcast through a mesh hierarchy in accordance with an embodiment of the invention. As shown in FIG. 6, tags 602, 604, and 606 may be stacked (i.e. pre-pended in sequence) to the broadcast packet 300. Three-levels of stacked tags are shown in this example. However, the level of stacked tags in a particular system implementation will depend upon the number of levels in the mesh hierarchy.

In this example with three-levels of stacked tags, the first tag pre-pended to the broadcast packet 300 is the mesh tag 602. The mesh tag 602 is used to determine the broadcast path of the packet through switches 102 forming a mesh 101. In one embodiment, the mesh tag 602 may comprise an originating switch identifier, and that identifier may be used to determine the broadcast path through the mesh 101.

The second tag “stacked on top of” the first tag 606 is the meta-mesh tag 604. The meta-mesh tag 604 is used to determine the broadcast path of the packet through the meshes 101 forming a meta-mesh 400. In one embodiment, the meta-mesh tag 604 may comprise an originating mesh identifier, and that identifier may be used to determine the broadcast path through the meta-mesh 400.

The third tag “stacked on top of” the second tag 604 is the meta-meta-mesh tag 606. The meta²-mesh tag 606 is used to determine the broadcast path of the packet through the meta-meshes 400 forming a meta²-mesh 500. In one embodiment, the meta²-mesh tag 606 may comprise an originating meta-mesh identifier, and that identifier may be used to determine the broadcast path through the meta²-mesh 500.

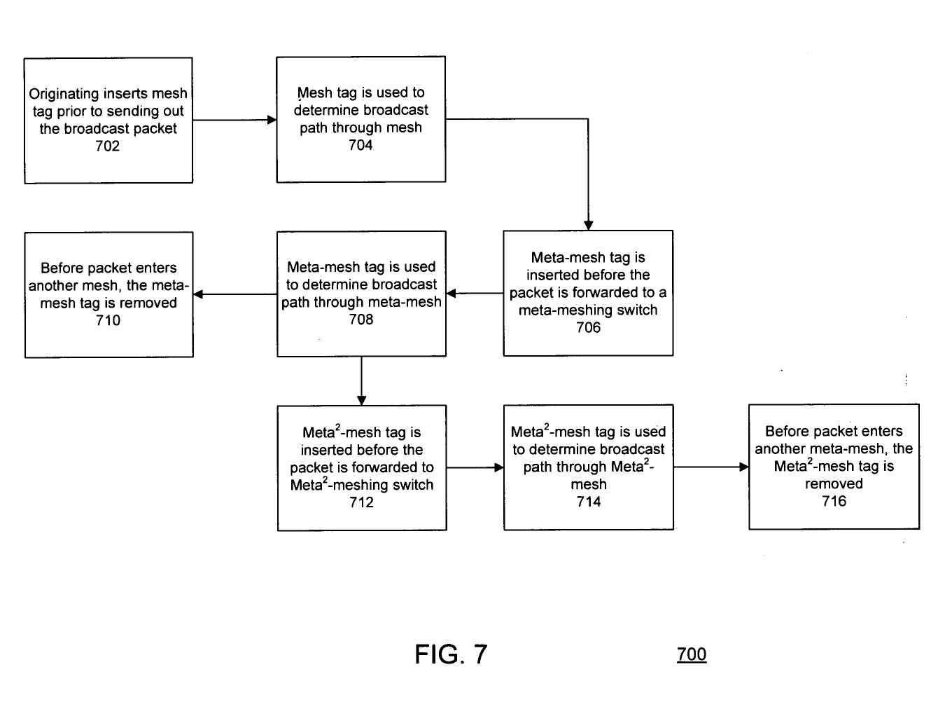

FIG. 7 is a flow chart depicting a method 700 of broadcasting a packet through a meta²-mesh of switches in accordance with an embodiment of the invention. The method 700 shown in FIG. 7 relates to a particular system implementation with three levels in the mesh hierarchy. Other particular system implementations may have a different number of levels in the mesh hierarchy, such as two levels, or four levels, or five levels, and so on.

In the first block 702, the originating switch inserts a mesh tag 602 prior to sending out the broadcast packet. This mesh tag 602 is then used by the other meshing switches to determine the broadcast path through the mesh, as indicated in the second block 704.

In the third block 706, a meta-mesh tag 604 is inserted into the packet before forwarding the packet to a meta-meshing switch 402. This meta-mesh tag 604 is then used by the meta-meshing switches 402 to determine the broadcast path through the meta-mesh 400, as indicated in the fourth block 708. Before the packet enters another mesh 101 of the meta-mesh 400, the meta-mesh tag 604 is removed, as shown in the fifth block 710.

In a sixth block 712, a meta²-mesh tag 606 is inserted into the packet before forwarding the packet to a meta²-meshing switch 502. This meta²-mesh tag 606 is then used by the meta²-meshing switches 502 to determine the broadcast path through the meta²-mesh 500, as indicated in the seventh block 714. Before the packet enters another meta-mesh 400 of the meta²-mesh 500, the meta -mesh tag 606 is removed, as shown in the eighth block 716.

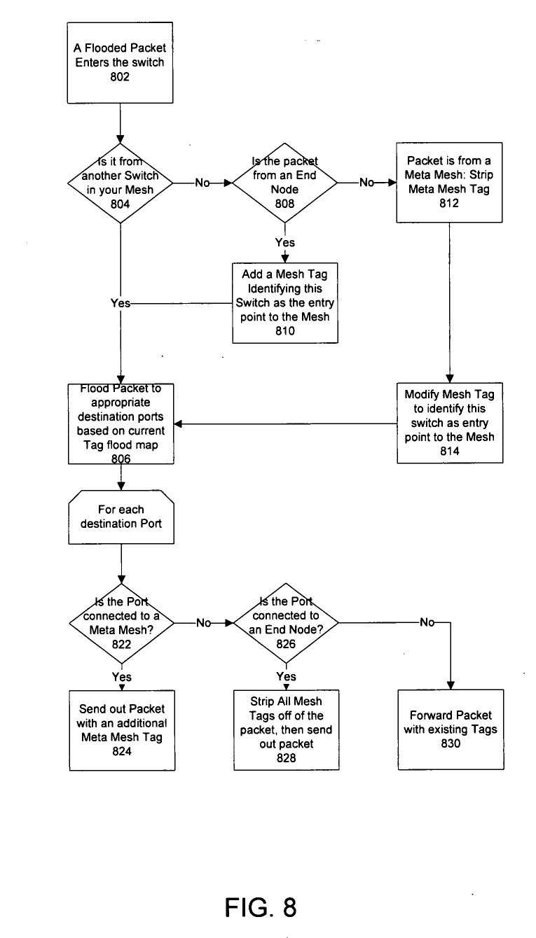

FIG. 8 is a flow chart depicting procedural steps performed by a meshing switch in processing a broadcast packet in accordance with an embodiment of the invention. Initially, a flooded (broadcast) packet enters 802 the switch via one of its ports.

A determination is then made 804 as to whether the packet is from another switch in the same mesh. If the packet is from another switch in the same mesh, then the packet may be flooded 806 to appropriate destination ports based on a flood (broadcast) map for the current tag (i.e. the current mesh tag).

Otherwise, if the packet is not from another switch in the same mesh, then a further determination is made 808 as to whether the packet is from an end node such that the packet is just entering the mesh. If the packet is from an end node, then a mesh tag is added 810 to identify this switch as the entry point to the mesh. Thereafter, the packet may be flooded 806 to appropriate destination ports based on a flood map for that tag.

On the other hand, if the packet is not from an end node (and not from another switch in the mesh), then the packet is from the meta-mesh. In that case, the switch strips 812 the meta-mesh tag from the packet and modifies 814 the mesh tag to identify this switch as the entry point to the mesh. Thereafter, the packet may be flooded 806 to appropriate destination ports based on a flood map for that tag.

For each destination port to which the packet is flooded 806, a determination is made 822 as to whether the port is connected to a meta-mesh. If the port is connected to a meta-mesh, then a meta-mesh tag is added to the packet and the packet is sent out 824 with the meta mesh tag.

Otherwise, if the port is not connected to a meta-mesh, then a further determination is made 826 as to whether the port is connected to an end node. If the port is connected to an end node, then all the mesh tags (i.e. any mesh tag, any meta-mesh tag, and so on) are stripped from the packet, and the packet is sent out 828 without any such mesh tags.

On the other hand, if the port is not connected to an end node, then the packet is forwarded 830 with the existing mesh tags in place.

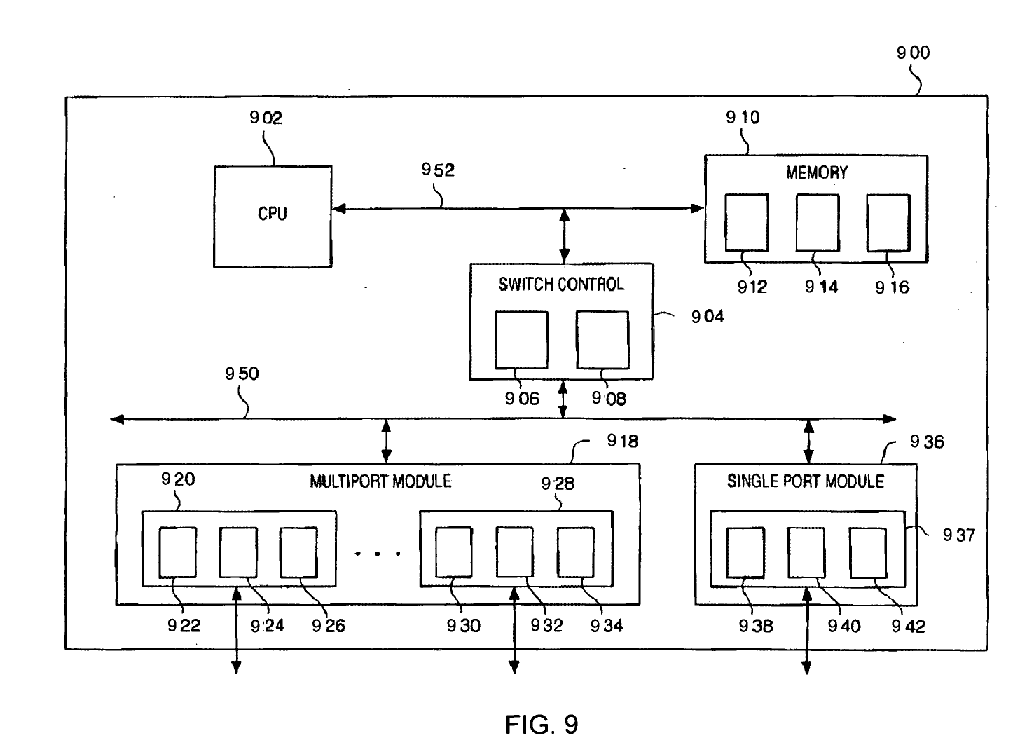

FIG. 9 is a diagram of an example switch 900 in accordance with an embodiment of the invention. The specific configuration of the switches used will vary depending on the specific implementation.

A central processing unit (CPU) 902 performs overall configuration and control of the switch 900 operation. The CPU 902 operates in cooperation with switch control 904, an application specific integrated circuit (ASIC) designed to assist CPU 902 in performing packet switching at high speeds required by modern networks.

The switch control 904 controls the “forwarding” of received packets to appropriate locations within the switch for further processing and/or for transmission out another switch port. Inbound and outbound high speed FIFOs (906 and 908, respectively) may be included with the switch control 904 for exchanging data over switch bus 952 with port modules. In accordance with an embodiment of the invention, the switch control ASIC 904 is configured to insert and remove tags from fixed locations in a packet, as may be necessary. For example, the aforementioned mesh and meta-mesh tags may be added to and/or removed from the broadcast packets.

Memory 910 may include a high and low priority inbound queue (912 and 914, respectively) and outbound queue 916. High priority inbound queue 912 holds received switch control packets awaiting processing by CPU 902 while low priority inbound queue 914 holds other packets awaiting processing by CPU 902. Outbound queue 916 holds packets awaiting transmission to switch bus 920 via switch control 904 through its outbound FIFO 908. CPU 902, switch control 904 and memory 910 may be configured to exchange information over processor bus 952 largely independent of activity on switch bus 920.

The ports of the switch may be embodied as plug-in modules that connect to switch bus 920. Each such module may be, for example, a multi-port module 918 having a plurality of ports in a single module or may be a single port module 936. A multi-port module provides an aggregate packet switch performance capable of handling a number of slower individual ports. For example, in one embodiment, both the single port module 936 and the multi-port module 918 may be configured to provide, for example, approximately 1 Gbit per second packet switching performance. The single port module 936 therefore can process packet switching on a single port at speeds up to 1 Gbit per second. The multi-port module 918 provides similar aggregate performance but distributes the bandwidth over, preferably, eight ports each operating at speeds, for example, of up to 100 Mbit per second.

Each port may include high speed FIFOs for exchanging data over its respective port. Specifically, each port, 920, 928, and 937, preferably includes an inbound FIFO 922, 930, and 938, respectively for receiving packets from the network medium connected to the port. Further, each port 920, 928, and 937, may include a high priority outbound FIFO 924, 932, and 910, respectively, and a low priority outbound FIFO 926, 934, and 942, respectively. The low priority outbound FIFOs may be used to queue data associated with transmission of normal packets while the high priority outbound FIFO is used to queue data associated with transmission of control packets. Each module (918 and 936) may include circuits (not specifically shown) to connect its port FIFOs to the switch bus 920.

As packets are received from a port, the packet data may be applied to the switch bus 920 in such a manner as to permit monitoring of the packet data by switch control 904. The switch control 904 may be configured to manage access to switch bus 920 by all port modules (i.e., 918 and 936). All port modules may “listen” to packets as they are received and applied by a receiving port module to switch bus 920. If a packet is to be forwarded to another port, switch control 904 may apply a trailer message to switch bus 920 following the end of the packet to identify which port should accept the received packet for forwarding to its associated network link.

Note that the above-described stacked tagging for switching is performed by network switches at the network layer 2. This advantageously provides a basis for increased performance in relation to routing which is performed at the network layer 3.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of processing a broadcast packet by a networking switch, the method comprising:
if the packet is received from another switch within a same switching mesh, then flooding the packet to appropriate destination ports based on a flood map corresponding to an existing mesh tag in the packet;
if the packet is received from an end node, then adding a new mesh tag to the packet and then flooding the packet to appropriate destination ports based on a flood map corresponding to the new mesh tag in the packet; and
if the packet is received from a meta mesh, then stripping an existing meta-mesh tag from the packet, modifying a mesh tag in the packet, and flooding the packet to appropriate destination ports based on a flood map corresponding to the modified mesh tag in the packet.

2. The method of claim 1, further comprising, for each destination port, determining if the port is connected to a meta mesh, and if the port is connected to a meta mesh, then adding a meta-mesh tag to the packet before sending the packet out of the port.

3. The method of claim 2, further comprising, if the port is not connected to a meta mesh, then further determining if the port is connected to an end node, and if the port is connected to an end node, then stripping all mesh-related tags off of the packet before sending the packet out of the port.

4. The method of claim 3, further comprising, if the port is connected to neither a meta mesh nor an end node, then forwarding the packet with existing mesh-related tags.

5. The method of claim 1, wherein the mesh tag comprises a switch identifier.

6. The method of claim 1, wherein the meta-mesh tag comprises a mesh identifier.

7. A networking switch comprising:
a controller configured to add a new meta-mesh tag to a packet prior to transmitting the packet to a meta mesh, wherein the meta mesh interconnects a plurality of meshes, wherein each said mesh comprises a plurality of switches, and wherein the meta-mesh tag determines a broadcast path through the meta mesh.

8. The switch of claim 7, wherein the controller is further configured to strip an existing meta-mesh tag from a packet received from a meta mesh.

9. The switch of claim 7, wherein the meta-mesh tag comprises a mesh identifier.

10. A packet switching apparatus with broadcast capability for use in a mesh hierarchy, the apparatus including:
a plurality of ports; and
a switch controller coupled to the plurality of ports,
wherein the switch controller is configured, upon determining that a packet is to be broadcast through the mesh hierarchy, to apply procedures stored in memory to add a new meta-mesh tag to the packet prior to the packet entering a meta mesh,
wherein the meta mesh interconnects a plurality of meshes,
wherein each said mesh comprises a plurality of switches, and
wherein the meta-mesh tag determines a broadcast path through the meta mesh.

11. The apparatus of claim 10, wherein the switch controller is further configured to strip an existing meta-mesh tag from a packet received from a meta mesh.

12. The apparatus of claim 10, wherein the meta-mesh tag comprises a mesh identifier.
